(19) United States
(12) Patent Application Publication
(10) Pub. No.: US 2013/0100370 A1
(43) Pub. Date: Apr. 25, 2013

(54) Liquid Crystal Display Module, Liquid Crystal Display Device and Liquid Crystal Display Panel Positioning Method

(71) Applicants: Shih hsiang Chen, Shenzhen (CN); Gang Yu, Shenzhen (CN)

(72) Inventors: Shih hsiang Chen, Shenzhen (CN); Gang Yu, Shenzhen (CN)

(21) Appl. No.: 13/375,415

(22) PCT Filed: Oct. 26, 2011
(86) PCT No.: PCT/CN2011/081355

§ 371 Date: Nov. 30, 2011

(30) Foreign Application Priority Data
Oct. 20, 2011 (CN) 20110320405.X

(51) Int. Cl. G02F 1/1333

(52) U.S. Cl. 349/58

(57) ABSTRACT

The present invention discloses a liquid crystal display (LCD) module, a LCD device and a LCD panel positioning method, wherein said LCD module comprises a rubber frame and a LCD panel. The rubber frame is provided with positioning structures which are corresponding to the four sides of the LCD panel and are used for limiting the LCD panel, and each said positioning structure comprises movable positioning parts which are used for tightly butting said LCD panel from at least two adjacent sides of the LCD panel and can be movably fixed on said rubber frame. Because at least two movable positioning parts, which are arranged in one positioning structure for limiting the position of the LCD panel and are positioned on the adjacent sides of the LCD panel, are used for tightly butting the LCD panel from the sides and are fixed on the rubber frame finally, the position of the LCD panel is determined during assembly; and then the LCD panel is positioned. The clearance caused by the different size of the LCD panels can be adjusted by the butting of the movable positioning parts during assembly. Thus, the present invention can be used in various LCD panels of different size caused by machining accuracy.

### TECHNICAL FIELD

The present invention relates to the field of Liquid crystal displays (LCDs), and more particularly to a LCD module, a LCD device and a LCD panel positioning method.

### BACKGROUND

A LCD module generally comprises a LCD panel, a backlight module and a frame structure. The frame structure comprises a rubber frame, and the LCD panel is fixed on the rubber frame.

As shown in FIG. 1 and FIG. 2, in the existing module design, a LCD panel 100 is positioned by the positioning blocks 210 arranged near the four corners of a rubber frame 200. In fact, the positioning blocks 210 are arranged on the four corners near the rubber frame, and the LCD panel 100 is positioned by limiting the four sides of the LCD panel 100. The lengths and the widths of the LCD panels for the modules of the same size will be different to some extent because of machining accuracy, and then such LCD panels cannot be accurately positioned; to solve the problem, the LCD panels are usually positioned by mold-making the rubber frames 200 again. However, the method not only increases the production cost, but also reduces the production efficiency; the other method to solve the problem is that: the positioning blocks 210 near the four corners are kept, but cushion blocks 400 (as shown in FIG. 3 and FIG. 4) of different thickness are added between the positioning blocks near the four corners and the LCD panel. Take the cushion blocks shown in the figure as an example, eight cushion blocks (made of rubber material) in total are used to provide adaptation to the LCD panels of different size. However, for the LCD panels of different size, the clearance corresponding to the positioning blocks are different. Thus, cushion blocks of different size should be manufactured to fit different clearance, causing trouble to the assembly and increasing man-hour for manufacturing the cushion blocks. Therefore, the manufacturing man-hour is increased, and the production efficiency is reduced.

### SUMMARY

The aim of the present invention is to provide a LCD module, a LCD device and a LCD panel positioning method thereof capable of accurately positioning the LCD panels of different size.

The purpose of the LCD module of present invention is achieved by the following technical schemes. A LCD module comprises a rubber frame and a LCD panel. The rubber frame is provided with positioning structures which are corresponding to the four sides of the LCD panel and are used for limiting the LCD panel. Wherein, each positioning structure comprises movable positioning parts which are used for tightly butting the LCD panel from two adjacent sides of the LCD panel and can be movably fixed on the rubber frame.

Preferably, the positioning structures are movable positioning parts which are used for tightly butting the LCD panel from the four sides of the LCD panel and are movably fixed on the rubber frame. By being tightly butted from the four sides, the LCD panel can be positioned in the central region of the rubber frame without small movement.

Preferably, each positioning structure comprises movable positioning parts which are used for tightly butting the LCD panel from three sides of the LCD panel and can be movably fixed on the rubber frame, and a fixed positioning part integrated with the rubber frame. By the mode of tightly butting the LCD panel from the three sides, the assembly steps can be reduced, and the positioning parts can be conveniently arranged because one positioning structure is used as a standard.

Preferably, each positioning structure comprises movable positioning parts which are used for tightly butting the LCD panel from two adjacent sides of the LCD panel and can be movably fixed on the rubber frame, and two fixed positioning parts integrated with the rubber frame. By the mode that the LCD panel is tightly butted from two sides and the other two sides are limited by the positioning structures, the assembly steps can be reduced, and the processing efficiency can be increased.

Preferably, the positioning parts positioned on the two adjacent sides of the LCD panel are mutually integrated to form positioning assemblies; each positioning assembly comprises a first retaining wall and a second retaining wall which are mutually perpendicular; the positioning assembly is arranged on at least one corner of the LCD panel. The positioning parts positioned on the two adjacent sides are integrated to form the mutually perpendicular positioning assemblies. Thus, the positioning assemblies are conveniently arranged on the corners of the LCD panel, and the LCD panel is easily assembled and positioned.

Preferably, the inside of the joint of the first retaining wall and the second retaining wall of each positioning assembly is provided with a concave structure for avoiding one corner of the LCD panel. The concave structure can prevent one corner of the LCD panel from being butted in one positioning structure. Thus, the LCD panel is prevented from being damaged.

Preferably, the number of the positioning assemblies is four, and the four positioning assemblies are respectively arranged on the four corners of the LCD panel. Because the four corners are respectively provided with a positioning assembly, the LCD panel is preferably adjusted to the center of the rubber frame; and because the four corners are respectively provided with a positioning assembly, each side of the LCD panel is positioned by two points. Thus, the positioning reliability is increased.

The bottom surface of each movable positioning part is bonded to the rubber frame by the double sided adhesive tape to be fixed. The fixing method is simple and is easy to perform. Of course, other fixing methods can be used as well.

A LCD device comprises the aforementioned LCD module.

The purpose of the LCD panel positioning method of the LCD module of the present invention is achieved by the following technical schemes. A LCD panel positioning method of a LCD module, wherein the LCD panel positioning method comprises the following steps:

A: Positioning the LCD panel from two adjacent sides of the LCD panel by the positioning structures; and

B: Fixing the movable positioning parts on the rubber frame after positioning the LCD panel from two adjacent sides of the LCD panel by the positioning structures;

Because at least two movable positioning parts, which are arranged in one positioning structure for limiting the position of the LCD panel and are positioned on the adjacent sides of the LCD panel, are used for tightly butting the LCD panel from the sides and are fixed on the rubber frame finally, the position of the LCD panel is determined during assembly, and then the LCD panel is positioned. Namely the movable positioning parts are added subsequently. The clearance caused by different size of the LCD panel can be adjusted by the butting of the movable positioning parts during assembly, and the movable positioning parts added subsequently can be fixed on the corresponding sides of the LCD panel in accordance with the size and the position of the LCD panel. Thus, the present invention can be used in various LCD panels of different size caused by machining accuracy. Therefore, it is not necessary to mold-make the rubber frames of the LCD panels of different size again, and it is not necessary to fill the clearance caused by different size by adding cushion blocks. Furthermore, both movable positioning parts and rubber frames can be produced in batches in advance in accordance with the unified specification. Thus, the production cost is saved, and the production efficiency is improved.

### BRIEF DESCRIPTION OF FIGURES

FIG. 1 is a simplified structural diagram of an existing LCD panel positioning method;

FIG. 2 is a partial enlarged view of A shown in FIG. 1;

FIG. 3 is a simplified diagram of a compensating positioning method of an existing LCD panel;

FIG. 4 is a partial enlarged view of A shown in FIG. 3;

FIG. 5 is a simplified structural diagram of one example of the present invention;

FIG. 6 is a partial enlarged view of A shown in FIG. 5;

FIG. 7 is a simplified structural diagram of a rubber frame of one embodiment of the present invention;

FIG. 8 is a simplified structural diagram of a positioning assembly of one embodiment of the present invention;

FIG. 9 is a schematic diagram of another embodiment of the present invention;

FIG. 10 is a partial enlarged view of A shown in FIG. 9;

FIG. 11 is a partial enlarged view of B shown in FIG. 9;

FIG. 12 is a schematic diagram of a third embodiment of the present invention.

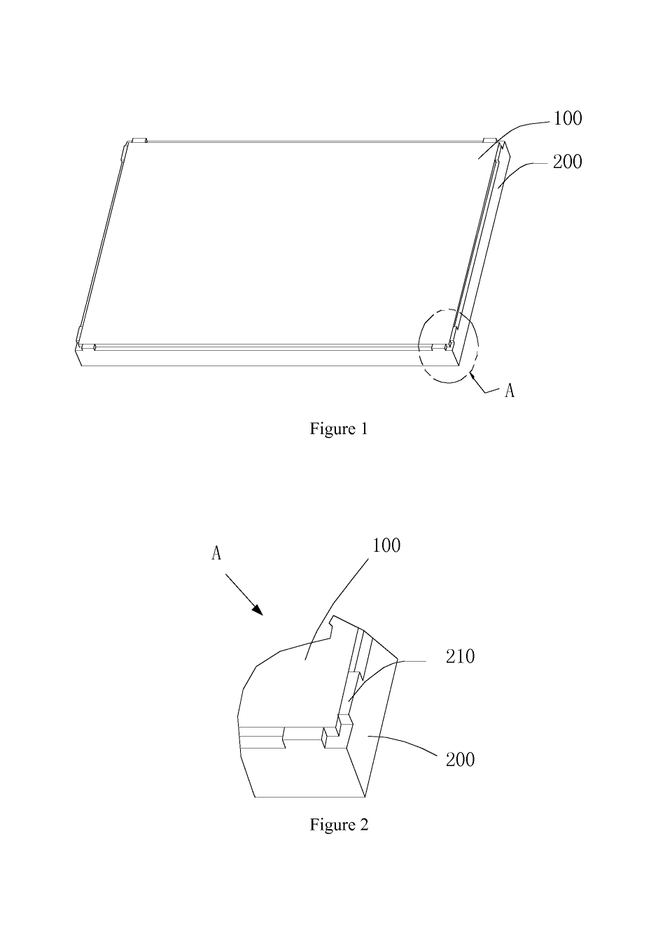

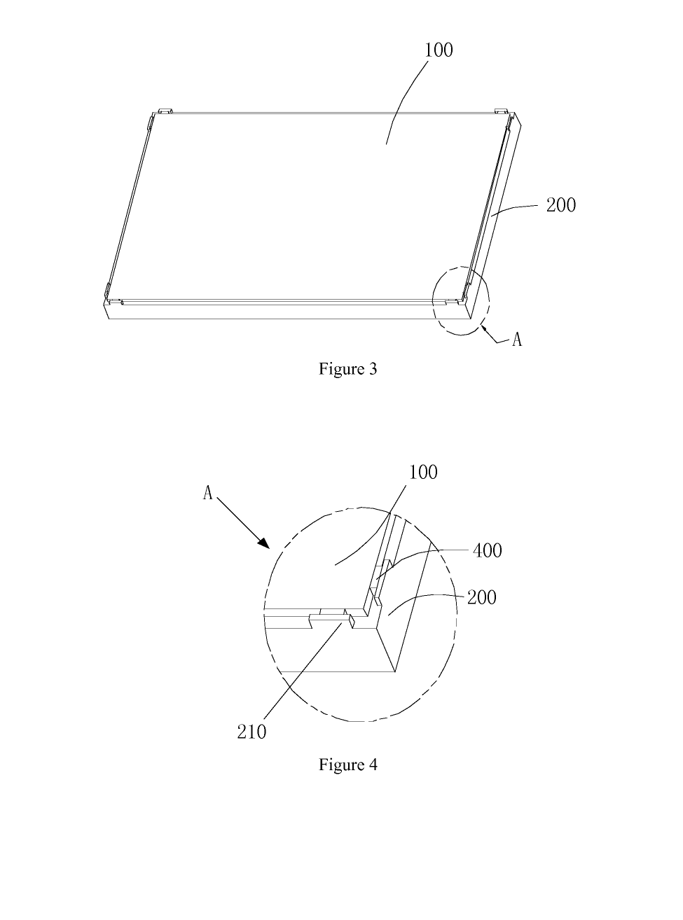

Wherein: 100. LCD panel; 200. rubber frame; 210. positioning block; 300. positioning assembly; 301. movable positioning part; 302. fixed positioning part; 310. concave structure; 320. first retaining wall; 330. second retaining wall; 400 cushion block.

### DETAILED DESCRIPTION

The present invention will further be described in detail in accordance with the figures and the preferred examples.

A LCD module generally comprises a LCD panel, a back light module arranged below the LCD panel and a peripheral frame structure. The frame structure comprises a rubber frame. The LCD panel is generally positioned by the positioning structures arranged on the rubber frame, and each positioning structure comprises at least two movable positioning parts which are tightly butted with the LCD panel from at least two adjacent sides of the LCD panel and can be movably fixed on the rubber frame. The positioning structures are mainly arranged on the rubber frame corresponding to the four sides close to the corners of the LCD panel. Of course, the LCD panel can be positioned as long as the four sides of the LCD panel are provided with positioning structures. Thus, when the LCD panel is positioned and assembled, the position of the LCD panel is determined first, and then the LCD panel is positioned by the positioning structures from two adjacent sides of the LCD panel. After the LCD panel is positioned by butting the rest two adjacent sides of the LCD panel through the movable positioning parts, the movable positioning parts are fixed on the rubber frame.

In the present invention, at least two movable positioning parts, which are arranged in one positioning structure and positioned on the adjacent sides of the LCD panel, are tightly butted with the LCD panel from the sides and are movably fixed on the rubber frame from the bottom, and the sides without movable positioning parts of the LCD panel are positioned by fixed positioning parts. Of course, the LCD panel can be positioned by movable positioning parts only. The LCD panel is butted and positioned by the movable positioning parts from the sides of the LCD panel, and the movable positioning parts are bonded to the rubber frame by the double side adhesive tape or fixed on the rubber frame by screws and the like from the bottom. Thus, for the LCD panels of different size caused by machining accuracy, it is not necessary to mold-make the rubber frames of the LCD panels of different size again; and it is not necessary to fill the clearance caused by different size by adding cushion blocks. Therefore, the production cost is saved, and the production efficiency is improved.

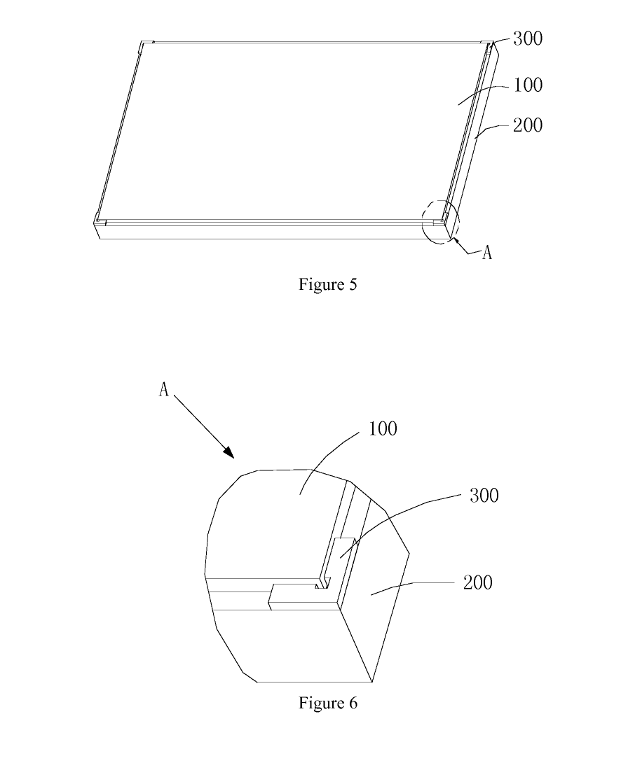

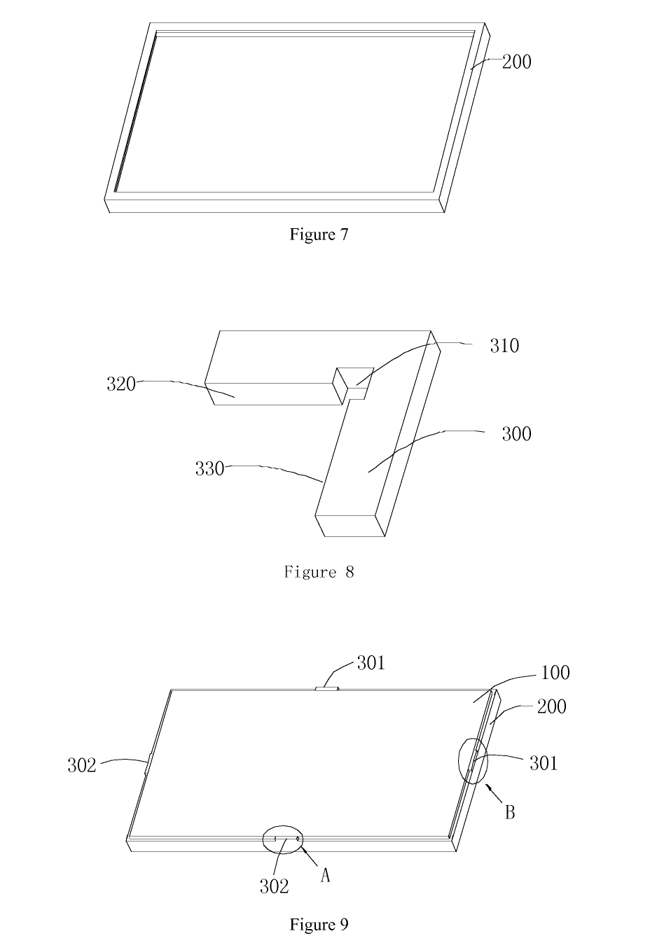

As shown in FIG. 5 and FIG. 6, this is one example of the present invention. A LCD panel 100 is positioned above a rubber frame 200, and the LCD panel 100 is positioned by positioning assemblies 300 on the periphery of the rubber frame 200. As shown in FIG. 7 and FIG. 8, the rubber frame 200 and the positioning assembly 300 are mutually independent, and the two are bonded by the double sided adhesive tape and can also be fixed by glue, screws and the like. The positioning assemblies 300 are respectively arranged on the four corners of the rubber frame. Each positioning assembly 300 comprises a first retaining wall 320 and a second retaining wall 330 which are mutually perpendicular and are used for limiting two sides of the LCD panel 100. The positioning assembly 300 is of an L-shaped structure, and the widths of its first retaining wall 320 and second retaining wall 330 are respectively corresponding to the two adjacent sides of the LCD panel. When the LCD panel 100 is positioned and assembled, the position of the LCD panel 100 is determined first, and then the positioning assemblies 300 are close to the four corners of the LCD panel 100, so that the first retaining wall 320 and the second retaining wall 330 of each positioning assembly 300 are respectively butted with the sides of the LCD panel 100. Thus, the LCD panel 100 can be accurately positioned by the positioning assemblies 300. The inside of the joint of the first retaining wall 320 and the second retaining wall 330 of each positioning assembly 300 is provided with a concave structure 310. The concave structure is used for preventing the LCD panel 100 from being damaged when one corner of the LCD panel 100 is butted in the positioning assembly 300.

In the example, one positioning assembly 300 is equivalent to an orthogonal structure formed by mutually connecting and fixing two movable positioning parts (namely the first retaining wall 320 and the second retaining wall 330) arranged on the sides of the LCD panel 100.

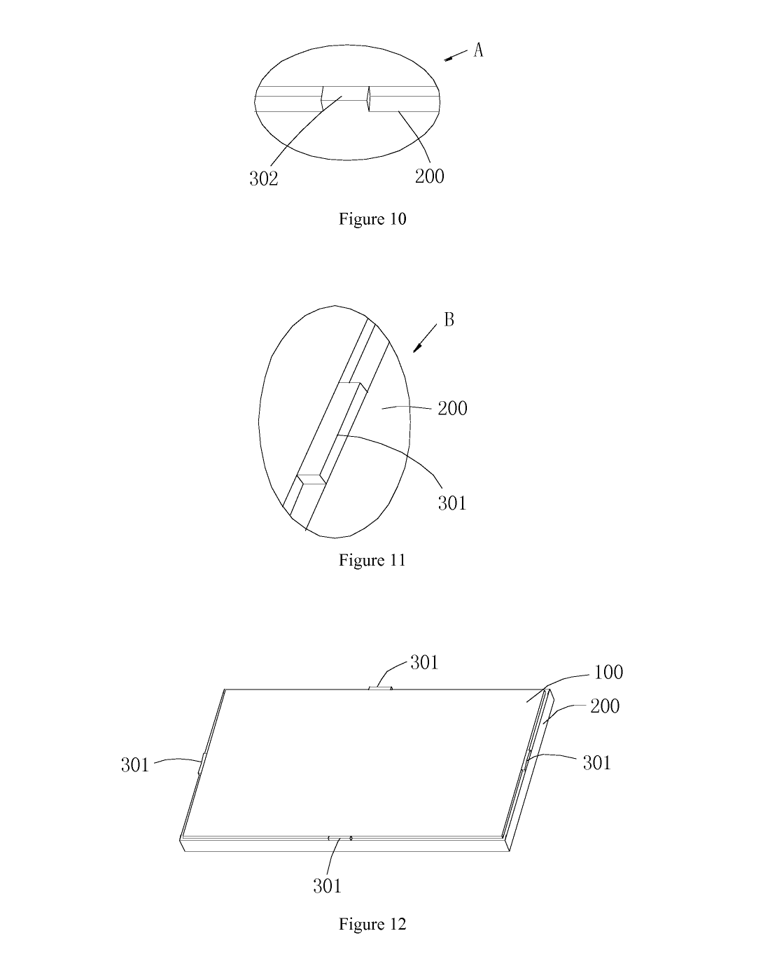

As shown in FIG. 9, this is the other example of the present invention. The example is different from the first example in that: in the example, movable positioning parts 301 are used to match fixed positioning parts 302 for positioning; the two movable positioning parts 301 are respectively arranged on the two adjacent sides of the LCD panel 100; and the fixed positioning parts 302 are arranged on the other two sides. Wherein, as shown in FIG. 11, the movable positioning part 301 is an externally arranged part, and the movable positioning part 301 and the rubber frame 200 are mutually independent; as shown in FIG. 10, the fixed positioning part 302 is integrated with the rubber frame 200, and belongs to a part of the rubber frame 200. When the LCD panel 100 is assembled and positioned, the two adjacent sides of the LCD panel 100 are tightly butted with the fixed positioning parts 302, the LCD panel 100 is tightly butted by two movable positioning parts 301 from the other two sides of the LCD panel 100, and the movable positioning parts 301 are bonded to the rubber frame 200 by glue after butting. Thus, the four sides of the LCD panel 100 are positioned.

In the example, the two fixed positioning parts 302 can be replaced by the movable positioning parts 301; as shown in FIG. 12, all the four sides of the LCD panel 100 are positioned by the movable positioning parts 301. Thus, the LCD panel 100 can be positioned in the central region of the rubber frame 200 without small movement. However, the time required for assembly will be reduced when the fixed positioning parts 302 are arranged. Similarly, in the first example shown in the FIG. 5 to FIG. 6, the number of the positioning assemblies 300 can be reduced as long as the four sides are positioned.

Of course, only one side of the LCD panel can be provided with a fixed positioning part, and the other three sides can be positioned by the movable positioning parts.

In the present invention, the structure of the movable positioning part is not limited to the block structure and the L-shaped structure of positioning assembly which are shown in the examples and the figures. The positioning parts and the positioning assemblies are used for butting the sides of the LCD panel. Thus, both the positioning parts and the positioning assemblies in various shapes can be achieved under the design of the present invention.

The present invention is described in detail in accordance with the above contents with the specific preferred examples. However, this invention is not limited to the specific examples. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A liquid crystal display (LCD) module, comprising: a rubber frame and a LCD panel; said rubber frame is provided with positioning structures which are corresponding to the four sides of the LCD panel and are used for limiting the LCD panel; each said positioning structure comprises movable positioning parts which are used for butting said LCD panel from the at least two adjacent sides of the LCD panel and can be movably fixed on the rubber frame.

2. The LCD module of claim 1, wherein said positioning structures are movable positioning parts which are used for tightly butting said LCD panel from the four sides of the LCD panel and can be movably fixed on said rubber frame.

3. The LCD module of claim 1, wherein each said positioning structure comprises movable positioning parts which are used for tightly butting said LCD panel from three sides of LCD panel and can be movably fixed on said rubber frame, and a fixed positioning part integrated with said rubber frame.

4. The LCD module of claim 1, wherein each said positioning structure comprises movable positioning parts which are used for tightly butting said LCD panel from two adjacent sides of the LCD panel and can be movably fixed on said rubber frame, and two fixed positioning parts integrated with said rubber frame.

5. The LCD module of claim 1, wherein said movable positioning parts positioned on the two adjacent sides of the LCD panel are mutually integrated to form a positioning assembly, and said positioning assembly comprises a first retaining wall and a second retaining wall which are mutually perpendicular; said positioning assembly is arranged on at least one corner of the LCD panel.

6. The LCD module of claim 5, wherein the inside of the joint of the first retaining wall and the second retaining wall of each said positioning assembly is provided with a concave structure for avoiding one corner of the LCD panel.

7. The LCD module of claim 5, wherein the number of said positioning assemblies is four, and the four positioning assemblies are respectively arranged on the four corners of the LCD panel.

8. The LCD module of claim 1, wherein the bottom surface of each said movable positioning assembly is bonded to the rubber frame by the double sided adhesive tape.

9. A LCD device comprises a LCD module of claim 1, wherein said LCD module comprises a rubber frame and an LCD panel; said rubber frame is provided with positioning structures which are corresponding to the four sides of the LCD panel and are used for limiting the LCD panel, and each said positioning structure comprises movable positioning parts which are used for tightly butting said LCD panel from two adjacent sides of the LCD panel and can be movably fixed on said rubber frame.

10. A LCD panel positioning method of a LCD module, comprising the following steps:
A: positioning the LCD panel from the adjacent sides of the LCD panel by the positioning structures;
B: after positioning said LCD panel by the movable positioning parts from the other two adjacent sides of the LCD panel, fixing said movable positioning parts on the rubber frame.

11. The LCD device of claim 9, wherein said positioning structures are movable positioning parts which are used for tightly butting said LCD panel from the four sides of the LCD panel and can be movably fixed on said rubber frame.

12. The LCD device of claim 9, wherein each said positioning structure comprises movable positioning parts which are used for tightly butting said LCD panel from three sides of LCD panel and can be movably fixed on said rubber frame, and a fixed positioning part integrated with said rubber frame.

13. The LCD device of claim 9, wherein each said positioning structure comprises movable positioning parts which are used for tightly butting said LCD panel from two adjacent sides of the LCD panel and can be movably fixed on said rubber frame, and two fixed positioning parts integrated with said rubber frame.

14. The LCD device of claim 9, wherein said movable positioning parts positioned on the two adjacent sides of the LCD panel are mutually integrated to form a positioning assembly, and said positioning assembly comprises a first retaining wall and a second retaining wall which are mutually perpendicular; said positioning assembly is arranged on at least one corner of the LCD panel.

15. The LCD device of claim 14, wherein the inside of the joint of the first retaining wall and the second retaining wall of each said positioning assembly is provided with a concave structure for avoiding one corner of the LCD panel.

16. The LCD device of claim 14, wherein the number of said positioning assemblies is four, and the four positioning assemblies are respectively arranged on the four corners of the LCD panel.

17. The LCD device of claim 9, wherein the bottom surface of each said movable positioning part is bonded to the rubber frame by the double sided adhesive tape.
